(19) United States
(12) Patent Application Publication
(10) Pub. No.: US 2020/0104784 A1
(43) Pub. Date: Apr. 2, 2020

(54) BAGGAGE DEPOSITING SYSTEM

(71) Applicant: HONDA MOTOR CO., LTD., Tokyo (JP)

(72) Inventors: Yuki Tanaka, Wako-shi (JP); Satoshi Miwa, Wako-shi (JP); Miyuki Shimota, Wako-shi (JP); Fumiaki Yamaguchi, Tokyo (JP)

(21) Appl. No.: 16/552,800

(22) Filed: Aug. 27, 2019

(30) Foreign Application Priority Data
Sep. 27, 2018 (JP) 2018-181284

(51) Int. Cl. G06Q 10/08

(52) U.S. Cl. CPC G06Q 10/083; G06Q 30/0645

(57) ABSTRACT

A depositing application acceptance unit accepts a baggage depositing request for requesting deposition, in a depositing space, of baggage stored in a vehicle. An end-of-use condition recognition unit recognizes an end-of-use time point and an end-of-use place of the vehicle. A baggage transfer asking unit transmits, to a communication terminal of a transfer service provider, baggage transfer asking information for asking for transfer of the baggage to the depositing space from the vehicle, the baggage transfer asking information including information of the end-of-use time point and the end-of-use place of the vehicle, when the depositing request acceptance unit accepts the baggage depositing request.

### INCORPORATION BY REFERENCE

The present application claims priority under 35 U.S.C. § 119 to Japanese Patent Application No. 2018-181284 filed on Sep. 27, 2018. The content of the application is incorporated herein by reference in its entirety.

### BACKGROUND OF THE INVENTION

### Field of the Invention

The present invention relates to a baggage depositing system.

### Description of the Related Art

There is conventionally proposed a system with which for supporting a user of a train, baggage held by the user is received at an entraining station, the baggage is delivered to an arrival station by train, and a deliverer is asked to deliver the baggage to the home of the user from the arrival station (for example, see Japanese Patent Laid-Open No. 2006-44916).

In the aforementioned conventional system, when the user checks the baggage, information is read, such as the names of the entraining and arrival stations, the time of arrival, and the address of the home, from a passenger ticket, a season ticket, a mobile phone or the like which includes an IC tag in which information regarding the user is implemented.

### SUMMARY OF THE INVENTION

Since the aforementioned system disclosed in Japanese Patent Laid-Open No. 2006-44916 targets a user for a train the operation time and the operation route of which are determined, the arrival station at which baggage arrives and the time of the arrival of the baggage can be easily identified from the information of the passenger ticket or the season ticket to access a deliverer.

On the contrary, when a user using a vehicle through car sharing or the like wants transfer of baggage to a temporary depositing space such as a rental locker from a place of return when returning the vehicle which ends to be used, the user suffers inconvenience of telling a place and a time for which asking for picking up the baggage is made to a deliverer.

The present invention is devised in view of such a background, and an object thereof is to provide a baggage depositing system which enables a user to easily request transfer of baggage to a depositing space from a vehicle.

There can be provided as a preferred aspect to achieve the aforementioned object a baggage depositing system including: a depositing request acceptance unit that accepts a baggage depositing request for requesting depositing, in a depositing space, of baggage stored in a vehicle; an end-of-use condition recognition unit that recognizes an end-of-use time point and an end-of-use place of the vehicle; and a baggage transfer asking unit that transmits, to a communication terminal of a transfer service provider which provides a service of transfer of the baggage to the depositing space from the vehicle, baggage transfer asking information for asking for the transfer, the baggage transfer asking information including information of the end-of-use time point and the end-of-use place, when the depositing request acceptance unit accepts the baggage depositing request.

In the aforementioned baggage depositing system, there may be employed a configuration including a use-of-a-vehicle prohibition unit that prohibits the vehicle from being used during a baggage collection scheduled period based on the end-of-use time point.

In the aforementioned baggage depositing system, there may be employed a configuration including: a baggage depositing recognition unit that recognizes that the baggage has been deposited in the depositing space;

and a depositing completion reporting unit that transmits, to a communication terminal of a user which has made the baggage depositing request, depositing completion information for reporting that the baggage has been completed to be deposited in the depositing space, when the baggage depositing recognition unit recognizes that the baggage has been deposited in the depositing space.

In the aforementioned baggage depositing system, there may be employed a configuration including a first depositing space extraction unit that extracts a first depositing space which is the depositing space in accordance with a selection condition designated by the baggage depositing request, wherein the baggage transfer asking unit transmits, to a communication terminal of the transfer service provider, the baggage transfer asking information for asking for the transfer of the baggage to the first depositing space from the vehicle.

In the aforementioned baggage depositing system, there may be employed a configuration including: a depositing space state-of-use recognition unit that recognizes a state of use of the depositing space; and an alternative depositing space information providing unit that transmits, to a communication terminal of a user which has made the baggage depositing request, information of a second depositing space which is the depositing space positioned within a predetermined distance from the first depositing space, when the depositing space state-of-use recognition unit recognizes that the first depositing space is in use.

In the aforementioned baggage depositing system, there may be employed a configuration including an inter-depositing space transfer asking unit that transmits, to the communication terminal of the transfer service provider, inter-depositing space transfer asking information for asking for transfer of the baggage to the first depositing space from the second depositing space, when the depositing space state-of-use recognition unit recognizes that the baggage is deposited in the second depositing space and when the depositing space state-of-use recognition unit recognizes that the first depositing space becomes vacant during a period of use of depositing the baggage which period is designated by the baggage depositing request.

In the aforementioned baggage depositing system, there may be employed a configuration in which the vehicle is used through rental or car sharing, and the end-of-use condition recognition unit recognizes the end-of-use time point on the basis of a usable period set to the vehicle, and recognizes the end-of-use place on the basis of a return place of the vehicle at an end of the usable period.

According to the aforementioned baggage depositing system, the end-of-use condition recognition unit recognizes the end-of-use time point and the end-of-use place of the vehicle. Then, when the request of depositing the baggage stored in the vehicle in the depositing space is accepted, the baggage transfer asking unit transmits, to the communication terminal of the transfer service provider, the baggage transfer asking information including the information of the end-of-use time point and the end-of-use place of the vehicle.

The transfer service provider receiving the baggage transfer asking information can recognize the end-of-use time point and the end-of-use place of the vehicle, receive the baggage from the vehicle arriving at the end-of-use place of the vehicle at the end-of-use time point thereof, and transfer it to the depositing space. Therefore, the user requesting the depositing of the baggage in the depositing space does not need to designate a handing-over time point and a handing-over place of the baggage from the vehicle, and can easily request transfer of the baggage to the depositing space from the vehicle.

### BRIEF DESCRIPTION OF THE DRAWINGS

FIG. 1 is a configuration diagram of a baggage depositing system;

FIG. 2 is an explanatory diagram of depositing management information;

FIG. 3 is an explanatory diagram of vehicle management information;

FIG. 4 is a first flowchart of processing of transferring baggage to a depositing space from a vehicle; and

FIG. 5 is a second flowchart of the processing of transferring the baggage to the depositing space from the vehicle.

### DETAILED DESCRIPTION OF THE PREFERRED EMBODIMENTS [1. Configuration of Baggage Depositing System]

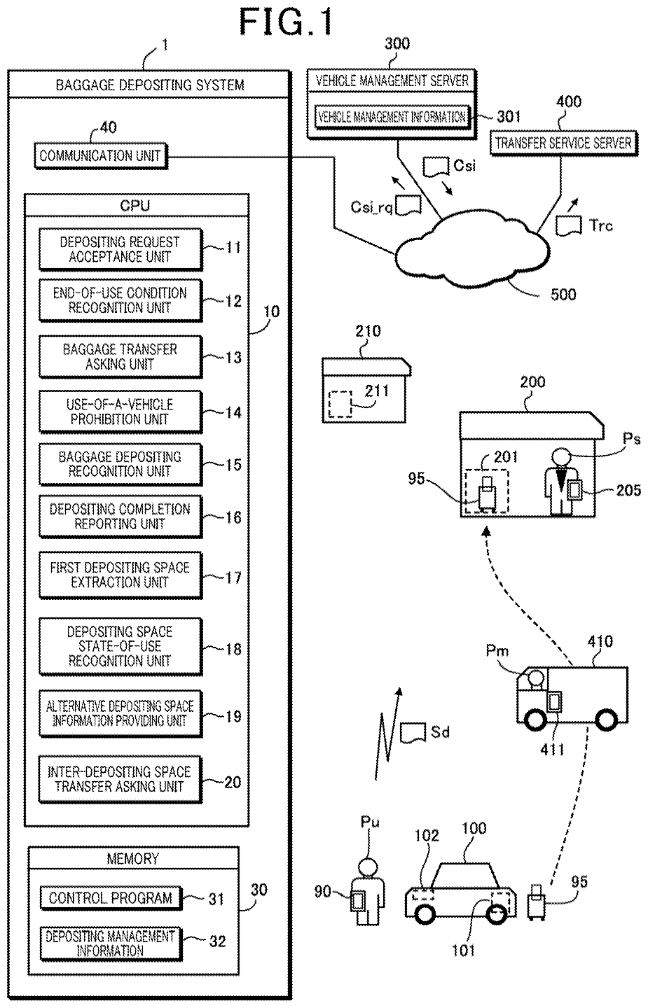

A configuration of a baggage depositing system 1 according to an embodiment is described with reference to FIG. 1 to FIG. 3. The baggage depositing system 1 manages lending of a temporary space for depositing baggage, such as a vacant space and a coin locker, in a store. FIG. 1 exemplarily shows a depositing space 201 provided at a store 200, and a depositing space 211 provided at a store 210.

A worker Ps in the store 200 operates a mobile terminal 205 to access the baggage depositing system 1, and applies for lending of the depositing space 201 which is a vacant space. In accordance with this application, the depositing space 201 is registered with the baggage depositing system 1, so that the depositing space 201 is enabled to be used by a user Pu. The same is true for the depositing space 211. FIG. 1 exemplarily shows a case of asking for, when the user Pu who uses a vehicle 100 through car sharing returns the vehicle 100, transfer of baggage 95 stored in a trunk 101 of the vehicle 100 to the depositing space 201 of the store 200.

The baggage depositing system 1 communicates with a vehicle management server 300 and a transfer service server 400 with a communication network 500. The vehicle management server 300 manages a state of use of each vehicle used through car sharing. The vehicle management server 300 stores therein vehicle management information 301 indicating states of use of vehicles.

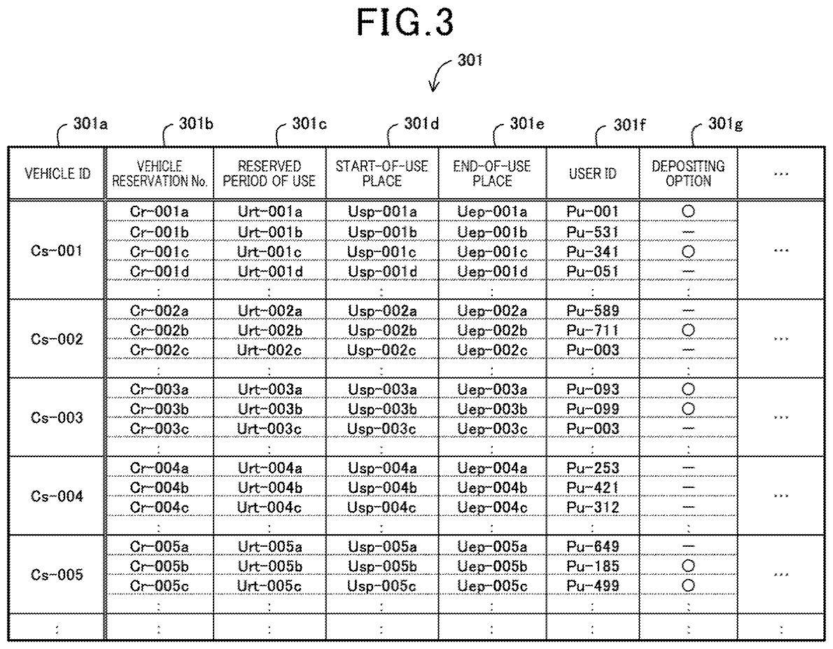

Referring to FIG. 3, the vehicle management information 301 records, for each vehicle provided through car sharing, a vehicle ID indicated by sign 301a, a vehicle reservation No. indicated by sign 301b, a reserved period of use indicated by sign 301c, a start-of-use place indicated by sign 301d, an end-of-use place indicated by sign 301e, a user ID indicated by sign 301f, and designation of a depositing option indicated by sign 301g. Moreover, the vehicle management information 301 records information of a virtual key for use of the vehicle (including operations of unlocking, locking, initiating, terminating and the like), and the information of the virtual key is transmitted to a mobile terminal (communication terminal) 90 of the user Pu, a mobile terminal (communication terminal) 411 of a person Pm in charge of delivery who transfers the baggage 95.

For the vehicle reservation No. of Cr-001a of a vehicle that is given the vehicle ID of Cs-001, for example, Urt-001a is recorded as the reserved period of use (period from the start of use to the end of use), lisp-001a as the start-of-use place, Uep-001a as the end-of-use place, and Pu-001 as the user ID, and the depositing option is set to be “present”. When the depositing option is set to be “present”, as mentioned later, information for asking for transfer of baggage to a depositing space from an end-of-use place is transmitted to the baggage depositing system 1 from the vehicle management server 300 when a vehicle is reserved to be used.

When receiving, from the baggage depositing system 1, baggage transfer asking information Trc for asking for transfer of the baggage 95 stored in the vehicle 100 to a depositing space, the transfer service server 400 arranges a delivery car 410 to transfer the baggage 95. The transfer service server 400 is run by a transfer service provider, and includes a function of a communication terminal of a transfer service provider of the present invention.

The baggage depositing system 1 is a computer system constituted of a central processing unit (CPU) 10, a memory 30, a communication unit 40 and the like. The memory 30 stores therein a program 31 for controlling the baggage depositing system 1, and depositing management information 32.

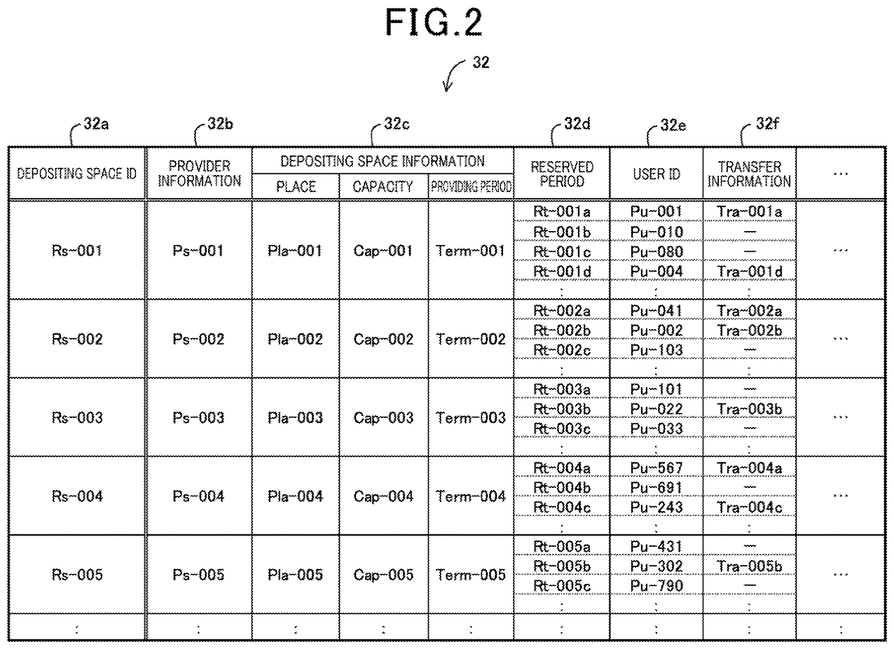

As shown in FIG. 2, the depositing management information 32 records, for each depositing space, a depositing space ID indicated by sign 32a, provider information indicated by sign 32b, depositing space information indicated by sign 32c, a reserved period indicated by sign 32d, a user ID indicated by sign 32e, and transfer information indicated by sign 32f. The depositing space information includes the place of the depositing space, the capacity thereof, and the providing period thereof.

For the depositing space which is given the depositing space ID of Rs-001, for example, Ps-001 is recorded as the provider information, and place Pla-001, capacity Cap-001 and providing period Term-001 as the depositing space information. Moreover, for the reserved period Rt-001, Pu-001 is recorded as the ID of a user who has made the reservation of depositing, and Tra-001a is recorded as the transfer information. The transfer information includes information of a baggage collection place and a baggage collection time for baggage to be transferred to the depositing space, the vehicle in which the baggage is stored, and the like.

The CPU 10 reads the control program 31 to execute it, and thereby, functions as a depositing request acceptance unit 11, an end-of-use condition recognition unit 12, a baggage transfer asking unit 13, a use-of-a-vehicle prohibition unit 14, a baggage depositing recognition unit 15, a depositing completion reporting unit 16, a first depositing space extraction unit 17, a depositing space state-of-use recognition unit 18, an alternative depositing space information providing unit 19 and an inter-depositing space transfer asking unit 20.

The depositing request acceptance unit 11 receives a baggage depositing request Sd transmitted from the mobile terminal 90 held by the user Pu to accept a depositing request of the baggage 95 in the depositing space 201. The end-of-use condition recognition unit 12 receives, from the vehicle management server 300, reservation-of-use information Csi indicating a reservation state of use of the vehicle 100, and thereby, recognizes an end-of-use time point and an end-of-use place of the vehicle 100 by the user Pu.

The baggage transfer asking unit 13 transmits, to the transfer service server 400, the baggage transfer asking information Trc for asking for transfer of the baggage 95 stored in the vehicle 100 to the depositing space 201. The use-of-a-vehicle prohibition unit 14 prohibits the vehicle 100 from being used except by the user Pu within an estimated period of baggage collection within which it is estimated that the baggage 95 is collected from the vehicle 100 for transfer to the depositing space 201.

The baggage depositing recognition unit 15 receives a depositing completion report transmitted from the mobile terminal 205 of the worker Ps in the store 200 or the mobile terminal 411 of the person Pm in charge of delivery in the delivery car 410, and thereby, recognizes that the baggage 95 stored in the vehicle 100 has been transferred to and stored in the depositing space 201. The depositing completion reporting unit 16 transmits, to the mobile terminal 90 of the user Pu, depositing completion information for reporting that the baggage 95 has been completed to be deposited in the depositing space 201, when the baggage depositing recognition unit 15 recognizes that the baggage 95 has been deposited in the depositing space 201.

The first depositing space extraction unit 17 extracts a first depositing space as a depositing space that matches a selection condition designated by the baggage depositing request Sd. Hereafter, the depositing space 201 is also stated as first depositing space 201, being supposed that it is extracted as the first depositing space, and the depositing space 211 is also stated as second depositing space 211, being supposed that it is extracted as a second depositing space.

The depositing space state-of-use recognition unit 18 recognizes a state of use of each depositing space recorded in the depositing management information 32 by receiving state-of-use information of the depositing space transmitted from a terminal device or the like in a store which provides the depositing space. When the first depositing space 201 is not vacant, the alternative depositing space information providing unit 19 extracts the second depositing space 211 positioned within a predetermined distance from the first depositing space 201, and transmits information of the second depositing space 211 to the mobile terminal 90 of the user Pu.

When it is recognized that the first depositing space 201 becomes vacant after the baggage is deposited in the second depositing space 211, the inter-depositing space transfer asking unit 20 transmits, to the transfer service server 400, inter-depositing space transfer asking information for asking for transfer of the baggage 95 to the first depositing space 201 from the second depositing space 211. [2. Processing of Transferring Baggage to Depositing Space from Vehicle]

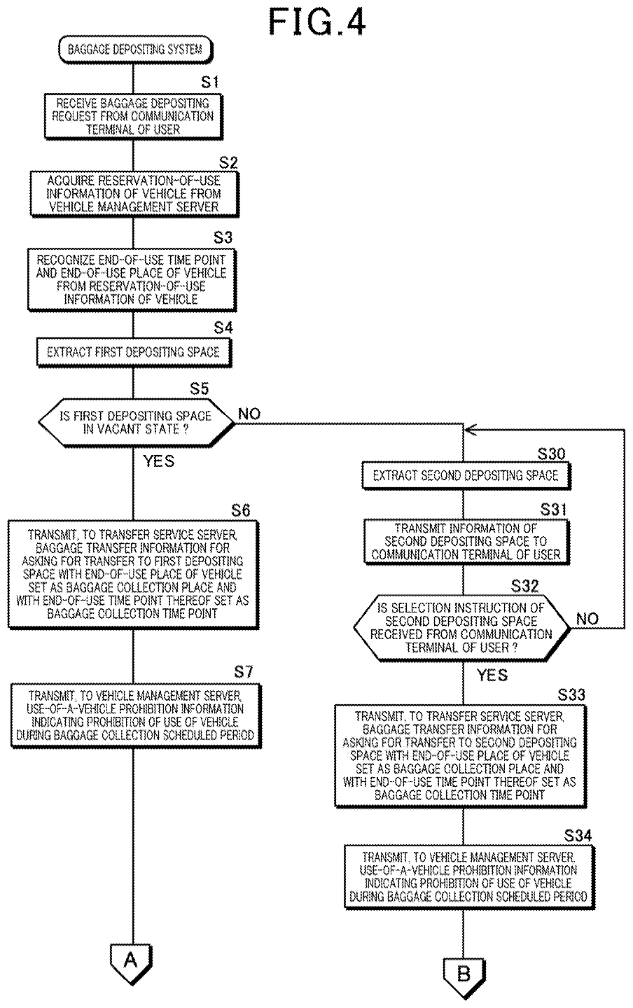

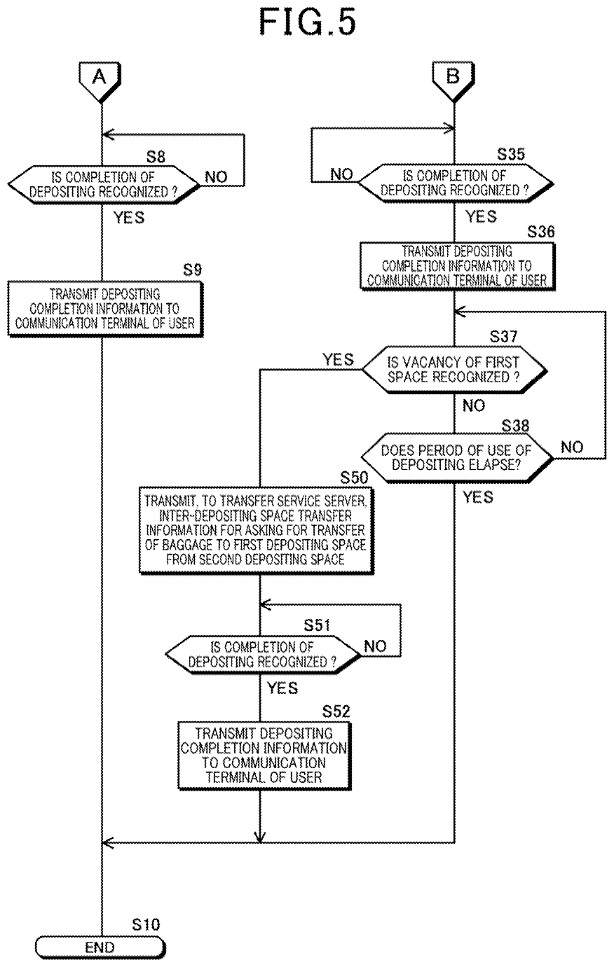

In accordance with flowcharts shown in FIG. 4 and FIG. 5, there is described processing performed by the baggage depositing system 1 for transferring the baggage 95 stored in the vehicle 100 to the first depositing space 201 and depositing it under the situation shown in FIG. 1.

The user Pu wants the baggage 95 stored in the vehicle 100 to be transferred to and temporarily deposited in an appropriate depositing space when returning the vehicle 100 being used through car sharing. Therefore, the user Pu operates the mobile terminal 90 to access an application site of a baggage depositing service provided by the baggage depositing system 1 and to request that the baggage 95 is transferred to and deposited in the depositing space from the return place of the vehicle 100 in timing when the vehicle 100 is returned.

Specifically, with the mobile terminal 90, the user inputs the vehicle reservation No. issued by the vehicle management server 300 when reserving use of the vehicle 100, and desired conditions for a depositing space (its place, capacity, period of use and the like) to ask for depositing of the baggage 95. Thereby, the baggage depositing request Sd including the vehicle reservation No. and the desired conditions for a depositing space is transmitted to the baggage depositing system 1 from the mobile terminal 90.

When receiving the baggage depositing request Sd from the mobile terminal 90 of the user Pu in step S1 of FIG. 4, the depositing request acceptance unit 11 of the baggage depositing system 1 puts the process forward to step S2. In step S2, the end-of-use condition recognition unit 12 transmits, to the vehicle management server 300, a reservation-of-use information request Csi_rq for requesting that reservation-of-use information of the vehicle 100 corresponding to the vehicle reservation No. included in the baggage depositing request Sd is provided. Then, the end-of-use condition recognition unit 12 receives reservation-of-use information Csi of the vehicle 100 transmitted from the vehicle management server 300.

As mentioned above with reference to FIG. 3, the vehicle management information 301 records, for each vehicle reservation No., information of the reserved period of use (corresponding to a usable period of the present invention), the start-of-use place, the end-of-use place and the like which are associated with one another. The vehicle management server 300 returns the reservation-of-use information Csi including these pieces of information to the baggage depositing system 1. In succeeding step S3, the end-of-use condition recognition unit 12 recognizes the end-of-use time point (end-of-lending time point) and the end-of-use place (return place of the vehicle 100) of the vehicle 100 from the reservation-of-use information Csi.

In next step S4, the first depositing space extraction unit 17 refers to the depositing management information 32 to extract a depositing space that matches the desired conditions designated by the baggage depositing request Sd. Supposing that the depositing space 201 of the store 200 is herein extracted as the first depositing space, it is hereinafter stated as the first depositing space 201.

In succeeding step S5, the depositing space state-of-use recognition unit 18 refers to the depositing management information 32 to determine whether or not the first depositing space 201 is vacant. Then, when the first depositing space 201 is vacant, the depositing space state-of-use recognition unit 18 puts the process forward to step S6. In step S6, the baggage transfer asking unit 13 transmits, to the transfer service server 400, the baggage transfer asking information Trc for asking for transfer of the baggage 95 to the first depositing space 201 with the end-of-use place of the vehicle 100 set as the baggage collection place and with the end-of-use time point thereof set as the baggage collection time point.

At the transfer service server 400 receiving the baggage transfer asking information Trc, there is arranged transfer of the baggage 95 to the first depositing space 201 from the end-of-use place with the delivery car 410. Then, the baggage 95 is transferred to the first depositing space 201 by the delivery car 410 and deposited in the first depositing space 201.

In succeeding step S7, the use-of-a-vehicle prohibition unit 14 transmits, to the vehicle management server 300, use-of-a-vehicle prohibition information indicating prohibition of use of the vehicle 100 during a baggage collection scheduled period set based on the end-of-use time point of the vehicle 100. This can prevent the vehicle 100 from being lent to a person except the user Pu during the baggage collection scheduled period, the vehicle 100 from moving from the end-of-use place, and thus, the baggage 95 from being disabled to be collected. Herein, the baggage collection scheduled period is set, for example, to be from 30 minutes before the end-of-use time point to 30 minutes thereafter.

In succeeding step S8 of FIG. 5, the baggage depositing recognition unit 15 receives the depositing completion information indicating that the baggage 95 has been deposited in the first depositing space 201 which information is transmitted from a terminal device disposed in the store 200, the mobile terminal 205 of the worker Ps in the store 200, or the mobile terminal 411 of the person Pm in charge of delivery, and thereby, puts the process forward to step S9 when recognizing that the baggage 95 has been completed to be deposited in the first depositing space 201.

In step S9, the depositing completion reporting unit 16 transmits, to the mobile terminal 90 of the user Pu, the depositing completion information for reporting that the baggage 95 has been deposited in the first depositing space 201. The mobile terminal 90 receiving the depositing completion information reports that the baggage 95 has been deposited in the first depositing space 201 by display on a display unit (not shown) or by speech output from a loud speaker (not shown). By recognizing this report, the user Pu can recognize that the baggage 95 has been deposited in the first depositing space 201.

On the other hand, when it is determined that the first depositing space 201 is not vacant in step S5 of FIG. 4, the depositing management information 32 puts the process forward to step S30. In step S30, the alternative depositing space information providing unit 19 refers to the depositing management information 32 to extract a second depositing space existing within a predetermined distance from the first depositing space 201. Supposing that the depositing space 211 of the store 210 is herein extracted as the second depositing space, it is hereinafter stated as the second depositing space 211 for the description.

In succeeding step S31, the alternative depositing space information providing unit 19 transmits information of the second depositing space 211 (its place, capacity and the like) to the mobile terminal 90 of the user Pu. In next step S32, the alternative depositing space information providing unit 19 determines whether or not information indicating selection of the second depositing space 211 is received from the mobile terminal 90 of the user Pu.

Then, when receiving the information indicating selection of the second depositing space 211, the alternative depositing space information providing unit 19 puts the process forward to step S33. On the other hand, when not receiving the information indicating selection of the second depositing space 211, the alternative depositing space information providing unit 19 puts the process to step S30, and in this case, another depositing space is to be extracted as the second depositing space.

In step S33, the baggage transfer asking unit 13 transmits, to the transfer service server 400, the baggage transfer asking information Trc for asking for transfer of the baggage 95 to the second depositing space 211 with the end-of-use place of the vehicle 100 set as the baggage collection place and with the end-of-use time point thereof set as the baggage collection time point.

At the transfer service server 400 receiving the baggage transfer asking information Trc, there is arranged transfer of the baggage 95 to the second depositing space 211 from the end-of-use place with the delivery car 410. Then, the baggage 95 is transferred to the second depositing space 211 by the delivery car 410 and deposited in the second depositing space 211.

In succeeding step S34, similarly to step S7 mentioned above, the use-of-a-vehicle prohibition unit 14 transmits, to the vehicle management server 300, the use-of-a-vehicle prohibition information indicating prohibition of use of the vehicle 100 during the baggage collection scheduled period. In succeeding step S35 of FIG. 5, the baggage depositing recognition unit 15 receives the depositing completion information indicating that the baggage 95 has been deposited in the second depositing space 211 which information is transmitted from a terminal device (not shown) disposed in the store 210 or the mobile terminal 411 of the person Pm in charge of delivery, and thereby, puts the process forward to step S36 when recognizing that the baggage 95 has been completed to be deposited in the second depositing space 211.

In step S36, the depositing completion reporting unit 16 transmits, to the mobile terminal 90 of the user Pu, the depositing completion information for reporting that the baggage 95 has been deposited in the second depositing space 211. The mobile terminal 90 receiving the depositing completion information reports that the baggage 95 has been deposited in the second depositing space 211 by display on the display unit (not shown) or by speech output from the loud speaker (not shown). By recognizing this report, the user Pu can recognize that the baggage 95 has been deposited in the second depositing space 211.

In the next loop process of steps S37 and S38, the inter-depositing space transfer asking unit 20 determines, with the depositing space state-of-use recognition unit 18, whether or not the first depositing space 201 is vacant in step S37, until a period of use of depositing the baggage 95 in the depositing space elapses in step S38.

Then, when the depositing space state-of-use recognition unit 18 determines that the first depositing space 201 is vacant in step S37, the process is put forward to step S50, and when the period of use of depositing elapses in step S38, the process is put forward to step S10.

In step S50, the inter-depositing space transfer asking unit 20 transmits, to the transfer service server 400, the inter-depositing space transfer information for asking for transfer of the baggage 95 to the first depositing space 201 from the second depositing space 211. At the transfer service server 400 receiving the inter-depositing space transfer information, there is arranged transfer of the baggage 95 to the first depositing space 201 from the second depositing space 211 with the delivery car 410.

Then, the baggage 95 is transferred to the first depositing space 201 from the second depositing space 211 by the delivery car 410 and deposited in the first depositing space 201. Thereby, the user Pu can receive the baggage 95 at the first depositing space 201 which is the originally desired depositing space.

In succeeding step S51, the inter-depositing space transfer asking unit 20 receives transfer completion information indicating that the baggage 95 has been transferred to the first depositing space 201 which information is transmitted from the terminal device (not shown) disposed in the store 200, the mobile terminal 205 of the worker Ps in the store 200, or the mobile terminal 411 of the person Pm in charge of delivery, and thereby, puts the process forward to step S52 when recognizing that the baggage 95 has been completed to be transferred to the first depositing space 201 from the second depositing space 211.

In step S52, the inter-depositing space transfer asking unit 20 transmits, to the mobile terminal 90 of the user Pu, the transfer completion information for reporting that the baggage 95 has been transferred to the first depositing space 201 from the second depositing space 211. The mobile terminal 90 receiving the transfer completion information reports that the baggage 95 has been deposited in the first depositing space 201 from the second depositing space 211 by display on the display unit (not shown) or by speech output from the loud speaker (not shown). By recognizing this report, the user Pu can confirm that the baggage 95 has been transferred to the first depositing space 201 from the second depositing space 211.

[3. Other Embodiments]

In the aforementioned embodiment, when receiving the baggage depositing request Sd from the mobile terminal 90 of the user Pu in step S1 of FIG. 4, the baggage depositing system 1 performs the processing of transferring the baggage 95 to the first depositing space 201 from the vehicle 100. As another configuration, there may be employed a configuration in which, when the user Pu accesses the vehicle management server 300 to reserve use of the vehicle 100, performing transfer of the baggage 95 to the depositing space from the vehicle 100 at the end of use of the vehicle 100 is beforehand designated. In this case, as shown in FIG. 3, selection of the depositing option 301g is recorded, the baggage depositing request is transmitted to the baggage depositing system 1 from the vehicle management server 300, and the processing in and after step S2 of FIG. 4 is performed.

While in the aforementioned embodiment, the alternative depositing space information providing unit 19 is included, and when the first depositing space is not vacant, transmits the information of the second depositing space to the mobile terminal 90 of the user, the effect of the present invention can be obtained even when the alternative depositing space information providing unit 19 is not included.

While in the aforementioned embodiment, the inter-depositing space transfer asking unit 20 is included, and when the first depositing space becomes vacant after the baggage is deposited in the second depositing space, the baggage is transferred to the first depositing space from the second depositing space, the effect of the present invention can be obtained even when the inter-depositing space transfer asking unit 20 is not included.

While in the aforementioned embodiment, the use-of-a-vehicle prohibition unit 14 prohibits the vehicle from being used during the baggage collection scheduled period, the effect of the present invention can be obtained even when the use-of-a-vehicle prohibition unit 14 is not included.

While in the aforementioned embodiment, the vehicle 100 used through car sharing is presented, the present invention can also be applied to a case where the vehicle 100 is a rental vehicle or a private vehicle. When the vehicle 100 is a private vehicle, the end-of-use condition recognition unit 12 can recognize the end-of-use place of the vehicle 100 with a global positioning system (GPS) receiver or the like provided in an in-vehicle device 102 of the vehicle 100 or the mobile terminal 90 of the user Pu. Therefore, the user Pu does not need to input the end-of-use place with the mobile terminal 90 when making the depositing request of the baggage 95 which request includes transfer to the depositing space from the vehicle 100 with respect to the baggage depositing system 1.

Moreover, when the in-vehicle device 102 has a navigation function and a destination is set therein, the end-of-use condition recognition unit 12 can recognize the destination as the end-of-use place and recognize an estimated arrival time point at the destination as the end-of-use time point. Therefore, the user Pu does not need to input the end-of-use place or the end-of-use time point with the mobile terminal 90 when making the depositing request of the baggage 95 which request includes transfer to the depositing space from the vehicle 100 with respect to the baggage depositing system 1.

Moreover, there may be employed a configuration in which the start-of-use time point and the start-of-use place of the vehicle by the user are acquired in the state where the user has already deposited the baggage in the depositing space, and asking for transfer of the baggage to the vehicle from the depositing space is accepted. According to this configuration, when the user who has deposited the baggage in the depositing space is to use the vehicle, labor to carry the baggage into the vehicle from the depositing space can be saved.

Moreover, there may be employed a configuration in which, when the user who continues using the vehicle wants the baggage to be picked up, the baggage depositing request can be transmitted with which the time and place at which the baggage is wanted to be picked up are designated. According to this configuration, when an article bought by the user is an article long time storage of which in the vehicle is not wanted (for example, a possibly soluble article, a heat-sensitive precision instrument or the like), asking for transfer of the article to an appropriate depositing space can be performed. Moreover, this configuration is effective also when the user has bought articles the capacity of which exceeds vehicle's load

Notably, FIG. 1 is a schematic view showing functional configurations of the baggage depositing system 1 which are segmented by their main contents of processing for easy understanding the invention of the present application, and the configuration of the baggage depositing system 1 may be configured by other segmentations. Moreover, the process of each constituent may be performed by one hardware unit, or may be performed by a plurality of hardware units. Moreover, the processes of the individual constituents shown in FIG. 1 may be performed by one program, or may be performed by a plurality of programs.

### REFERENCE SIGNS LIST

1 Baggage depositing system
10 CPU
11 Depositing request acceptance unit
12 End-of-use condition recognition unit
13 Baggage transfer asking unit
14 Use-of-a-vehicle prohibition unit
15 Baggage depositing recognition unit
16 Depositing completion reporting unit
17 First depositing space extraction unit
18 Depositing space state-of-use recognition unit
19 Alternative depositing space information providing unit
20 Inter-depositing space transfer asking unit
30 Memory
31 Control program
32 Depositing management information
90 Mobile terminal of user
95 Baggage
100 Vehicle
101 Trunk
102 In-vehicle device
200, 210 Store
201 First depositing space
205 Mobile terminal of provider of depositing space
211 Second depositing space
300 Vehicle management server
301 Vehicle management information
400 Transfer service server
500 Communication network

What is claimed is:

1. A baggage depositing system comprising:
a depositing request acceptance unit that accepts a baggage depositing request for requesting depositing, in a depositing space, of baggage stored in a vehicle;
an end-of-use condition recognition unit that recognizes an end-of-use time point and an end-of-use place of the vehicle; and
a baggage transfer asking unit that transmits, to a communication terminal of a transfer service provider which provides a service of transfer of the baggage to the depositing space from the vehicle, baggage transfer asking information for asking for the transfer, the baggage transfer asking information including information of the end-of-use time point and the end-of-use place, when the depositing request acceptance unit accepts the baggage depositing request.

2. The baggage depositing system according to claim 1, comprising a use-of-a-vehicle prohibition unit that prohibits the vehicle from being used during a baggage collection scheduled period based on the end-of-use time point.

3. The baggage depositing system according to claim 1, comprising:
a baggage depositing recognition unit that recognizes that the baggage has been deposited in the depositing space; and
a depositing completion reporting unit that transmits, to a communication terminal of a user which has made the baggage depositing request, depositing completion information for reporting that the baggage has been completed to be deposited in the depositing space, when the baggage depositing recognition unit recognizes that the baggage has been deposited in the depositing space.

4. The baggage depositing system according to claim 1, comprising
a first depositing space extraction unit that extracts a first depositing space which is the depositing space in accordance with a selection condition designated by the baggage depositing request, wherein
the baggage transfer asking unit transmits, to a communication terminal of the transfer service provider, the baggage transfer asking information for asking for the transfer of the baggage to the first depositing space from the vehicle.

5. The baggage depositing system according to claim 4, comprising:
a depositing space state-of-use recognition unit that recognizes a state of use of the depositing space; and
an alternative depositing space information providing unit that transmits, to a communication terminal of a user which has made the baggage depositing request, information of a second depositing space which is the depositing space positioned within a predetermined distance from the first depositing space, when the depositing space state-of-use recognition unit recognizes that the first depositing space is in use.

6. The baggage depositing system according to claim 5, comprising an inter-depositing space transfer asking unit that transmits, to the communication terminal of the transfer service provider, inter-depositing space transfer asking information for asking for transfer of the baggage to the first depositing space from the second depositing space, when the depositing space state-of-use recognition unit recognizes that the baggage is deposited in the second depositing space and when the depositing space state-of-use recognition unit recognizes that the first depositing space becomes vacant during a period of use of depositing the baggage which period is designated by the baggage depositing request.

7. The baggage depositing system according to claim 1, wherein
the vehicle is used through rental or car sharing, and
the end-of-use condition recognition unit recognizes the end-of-use time point on the basis of a usable period set to the vehicle, and recognizes the end-of-use place on the basis of a return place of the vehicle at an end of the usable period.
